(19) United States
(12) Patent Application Publication
(10) Pub. No.: US 2013/0222120 A1
(43) Pub. Date: Aug. 29, 2013

(54) REMOTE CONTROL SYSTEM HAVING AN UPDATABLE WIRELESS TAG

(71) Applicant: Yong Dae Jo, Seoul (KR)

(72) Inventor: Yong Dae Jo, Seoul (KR)

(21) Appl. No.: 13/881,753

(22) PCT Filed: Oct. 27, 2011
(86) PCT No.: PCT/KR2011/008070

§ 371 Date: Apr. 26, 2013

(30) Foreign Application Priority Data
Oct. 27, 2010 (KR) 10-2010-0105379

(51) Int. Cl. G06K 19/07

(52) U.S. Cl. CPC G06K 19/0727
USPC 340/10.42

(57) ABSTRACT

A remote control system having an updatable wireless tag, includes: an antenna unit that transmits and receives wireless signals; a plurality of button units, each of which includes a wireless tag unit and a first switch unit, wherein when a corresponding button provided in a remote controller is selected, remote controller signal information for controlling a function of an electronic product stored in the wireless tag unit is transmitted through the antenna unit; and a second switch unit that interconnects the antenna unit and each wireless tag unit provided in the plurality of button units such that information for updating the remote controller may be simultaneously transmitted to each wireless tag unit when a button for updating the remote controller is selected, in which the wireless tag unit of the button unit stores inherent identification information of the wireless tag unit and the remote controller signal information.

### TECHNICAL FIELD

The present invention relates to a remote controller using an RFID method, and more particularly, to a remote control system which can update a function of each button on the remote controller through an RFID method in a simple way.

### BACKGROUND ART

In recent years, a plurality of types of electronic products, for example, a TV, a set-top box, and an air conditioner, are used in the modern home. Many of these electronic products are controlled by a remote controller and a usage rate of such remote controllers is expected to gradually increase in the future.

Typically, a single remote controller can control only one electronic product and even the same kinds of electronic products may use a different remote controller when manufacturers are different from each other. For this reason, the same number of remote controllers as the electronic products is used in each home.

Since each home has a plurality of remote controllers, it is difficult to manage remote controllers.

In addition, when the electronic product is replaced or a new function is added, the remote controller needs to be replaced. In this case, it is necessary to purchase a new remote controller and discard the existing remote controller, which results in many problems in terms of recycling of resources.

The above-described problems may be solved by updating a function assigned to each button on the corresponding remote controller when a function of the electronic product is updated or the electronic product is replaced, with a single remote controller. However, research on such updates has yet to become active.

Moreover, current research about updates has a quite cumbersome problem in that there is a need to independently update each button one by one in order to update the remote controller.

### DISCLOSURE

### Technical Problem

In order to address the above-described problems, an object of the present invention is to provide a system and a method capable of updating remote controller signal information assigned to each button provided in the remote controller through a simple operation.

Furthermore, in order to address the above-described problems, an object of the present invention is to provide a computer-readable recording medium which stores a program to execute the above-described method.

### Technical Solution

In order to achieve the above-described purpose, the present invention provides a remote control system having an updatable wireless tag which includes: an antenna unit that transmits and receives wireless signals; a plurality of button units, each of which includes a wireless tag unit and a first switch unit, wherein when a corresponding button provided in a remote controller is selected, remote controller signal information for controlling a function of an electronic product stored in the wireless tag unit is transmitted through the antenna unit; and a second switch unit that interconnects the antenna unit and each wireless tag unit provided in the plurality of button units such that information for updating the remote controller, which is received from an external source, may be simultaneously transmitted to each wireless tag unit when a button for updating the remote controller is selected, in which the wireless tag unit of the button unit stores inherent identification information of the wireless tag unit and the remote controller signal information, and the first switch unit connects the wireless tag unit with the antenna unit when a button corresponding to the button unit is selected, and information for updating the remote controller includes the wireless tag identification information and remote controller signal information to be stored in a wireless tag corresponding to the identification information.

Here, the wireless tag unit may be configured to simultaneously transmit remote controller signal information and the wireless tag identification information, or to transmit only the remote controller signal information.

Further, a connection path with the first switch unit and a connection path with the second switch unit may be independently provided or may be provided such that the first switch unit and the second switch unit are interconnected.

In this case, it is preferable that the first switch unit and the second switch unit be configured to have a three-way switch. It is preferable that a common terminal of the first switch unit be connected to the wireless tag unit, a first terminal of the first switch unit be connected to a first terminal of the second switch unit, a second terminal of the first switch unit be connected to a second terminal of the second switch unit, when the button corresponding to the first switch unit is selected, the common terminal of the first switch unit be connected to the second terminal of the first switch unit, and when the button corresponding to the second switch unit is selected, the common terminal of the second switch unit be connected to the first terminal of the second switch unit.

Furthermore, it is preferable that the remote control system may further include a button for transmitting a signal indicating the update and a button for transmitting a signal indicating the end of the update.

Further, it is preferable that the remote control system may include a plurality of control groups each having the button unit and the second switch unit so as to control the different electronic products according to the control group.

Moreover, it is preferable that the remote control system may further include an update unit that receives a signal from the external device which provides update information and transmits a signal for changing the remote controller signal information stored in the wireless tag unit using the update information.

Here, it is preferable that the update unit may include an external connection unit that transmits and receives data to or from the external device; a read/write unit that generates a signal for changing remote controller signal information stored in the wireless tag unit using the update information received from the external device through the external connection unit, and transmits information received from the antenna unit to the external device through the external connection unit; and a second antenna unit that performs data transceiving between the read/write unit and the button unit via wireless communication with the antenna unit.

Further, a computer is preferably used as the external device.

In order to achieve above-described purpose, the invention provides a computer-readable recording medium storing a program to implement the above-described method.

### Advantageous Effects

According to the invention, it is possible to control a plurality of electronic products with a single remote controller and it is possible to update easily even when the electronic product to be controlled is changed.

In addition, the remote control system of the invention may be implemented in a non-powered manner using RFID technology.

Furthermore, the remote control system of the invention may easily update a function assigned to each button using the electronic product to be controlled or using a computer having an update program installed therein.

### DESCRIPTION OF DRAWINGS

FIG. 1 is a block diagram illustrating a configuration of an embodiment of the invention.

FIG. 2 is a block diagram illustrating a configuration of an embodiment of a wireless tag unit of the invention.

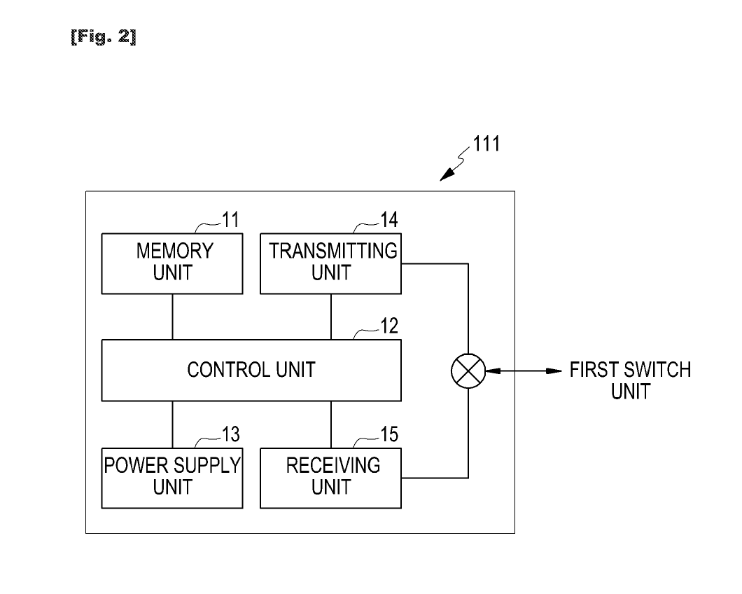

FIG. 3 is a block diagram illustrating a configuration of another embodiment of the invention.

FIG. 4 is a block diagram illustrating a configuration of another embodiment of the invention and illustrates an example in which a first switch unit and a second switch unit have different connection paths.

FIG. 5 is a block diagram illustrating a configuration of another embodiment of the invention and illustrates an example in which the first switch and the second switch are configured with a three-way switch.

FIG. 6 illustrates an example of an update system implemented in, for example, electronic products according to the invention.

FIG. 7 is a block diagram illustrating a configuration of another embodiment of the invention and illustrates an example in which a remote control system further includes an update unit.

FIG. 8 illustrates an example of an update system implemented in, for example, a computer.

FIG. 9 illustrates an example of a screen when the invention is connected to, for example, a computer.

### MODES OF THE INVENTION

According to the invention, a function assigned to each button provided in the remote controller can be updated by receiving a signal from an external source.

In the invention, the term “update” is used to indicate newly changing remote controller signal information transmitted when each button is pressed.

An external signal may be transmitted from electronic products controlled by the remote controller, a separate device having an update function of the remote controller, or a computer having remote controller update software installed therein, in a wired or wireless manner.

Hereinafter, exemplary embodiments of the invention will be described in detail with reference to the accompanying drawings.

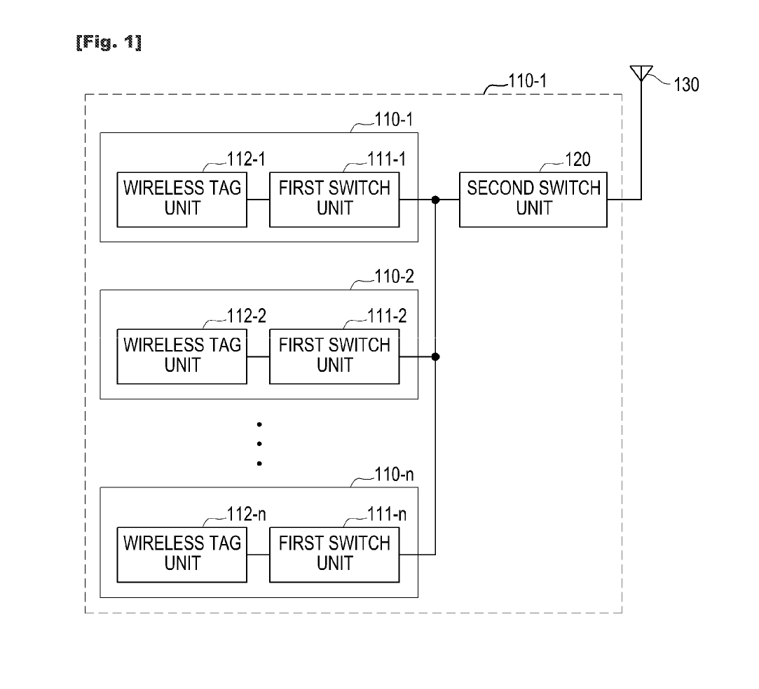

FIG. 1 is a block diagram illustrating a configuration of an embodiment of the invention, and illustrates a case in which the update can be possible when information for updating the remote controller is transmitted from the external source with wireless signals.

The remote control system of the invention includes a plurality of button units 110-1, 110-2, . . . , and 110-n, a second switch unit 120, and an antenna unit 130. Each of the button units 110-1, 110-2, . . . , and 110-n includes wireless tag units 112-1, 112-2, . . . , and 112-n and first switch units 111-1, 111-2, . . . , and 111-n.

Hereinafter, when referring any one button unit without specifying a particular button unit among the plurality of button units, it is represented as the button unit 110, a wireless tag unit therein is represented as the wireless tag unit 112, and a first switch unit is represented as the first switch unit 111.

The wireless tag unit 112 has the same configuration as a general RFID tag.

In general, the wireless tag unit includes a memory unit 11, a control unit 12, a power supply unit 13, a transmitting unit 14 and a receiving unit 15.

The memory unit 11 stores wireless tag unit identification information and remote controller signal information for controlling electronic products.

The power supply unit 13 supplies power to each component composing the wireless tag unit 112.

Power may be supplied through the power supply unit 13 in two ways.

One way is that a component capable of supplying its own power with, for example, an internal battery is provided and power supplied from this component is supplied to each component of the wireless tag unit 112. The other way is that power is generated using RF signals received from the external source and generated power is provided to each component of the wireless tag unit 112.

When power is generated using RF signals, it is preferable that an electronic product controlled by the remote controller transmit RF signals or RF signals be received from a separate device from which RF signals are transmitted.

With such a configuration, since the remote control system of the invention may be used in a non-powered manner that does not require its own power, it is unnecessary to replace a battery or charge.

The transmitting unit 14 transmits information stored in the memory unit 11 under the control of the control unit 12.

The receiving unit 15 receives signals transmitted from the external source.

The control unit 12 performs control such that when power is supplied from the power supply unit 13, information stored in the memory unit 11 is transmitted through the transmitting unit 14, and when a signal for updating the signal stored in the memory unit 11 is received from the receiving unit 15, this information is stored in the memory unit 11 in place of existing information so as to update information stored in the memory unit 11.

A receiving format of information to update information stored in the memory unit 11 corresponds to the format which is used to store information in the RFID tag in a general RFID writer.

This format is determined by the communication protocol between an RFID writer and an RFID tag and can be changed when the protocol is changed.

Further, the format may be determined by an independent protocol different from another RFID tag.

For example, when a code to indicate a signal for changing the stored information, a code to indicate wireless tag identification information, and a code to indicate information to be stored in the wireless tag are received together in one signal, the control unit 12 of the wireless tag unit 111 having corresponding identification information can control such that the information stored in the memory unit 11 is changed to newly received information.

On the other hand, when the information stored in the memory unit 11 is transmitted through the transmitting unit 14, only remote controller signal information among the information stored in the memory unit 11 may be transmitted, or wireless tag unit identification information and remote controller signal information may be simultaneously transmitted.

Returning to FIG. 1, when a button corresponding to the button unit 110 is selected, the first switch unit 111 interconnects the wireless tag unit 112 and the antenna unit 130.

That is, when a user presses a specific button to perform a certain function of the electronic product, the first switch unit 111 of the button unit 110 corresponding to the button interconnects the wireless tag unit 112 and the antenna unit 130 so as to transmit the information stored in the memory unit 11 of the wireless tag unit 112 through the antenna unit 130.

Here, the meaning of the phrase “button is selected” may be changed depending on a type of button and an operation method. In a general remote controller having a press button, a signal is transmitted at the moment of pressing or releasing the press button, and in this case, the phrase “button is selected” refers to pressing of the button or returning to the original state after pressing. In touch screen type remote controller, the phrase “button is selected” indicates that a region corresponding to the button is touched.

In addition, when the button remains pressed until re-pressing when a button is pressed once, in this case, the state of being pressed refers to being selected continuously.

The antenna unit 130 performs an antenna function for transceiving wireless signals.

The second switch unit 120 is a component used for updating, and interconnects the antenna unit 130 and the wireless tag unit 112 of all of the button units 110 so as to simultaneously transmit the information received from the external source for updating the remote controller to each wireless tag unit when a button for updating the remote controller is pressed.

The first switch unit 111 connects only the wireless tag unit 112, which corresponds to one user-pressed button for performing a function, with the antenna unit 130. However, the second switch unit 120 connects the antenna unit 130 with wireless tag units 112-1, 112-2, . . . , and 112-n of all of the button units 110-1, 110-2, . . . , and 110-n.

That is, when the second switch unit 120 is connected once, it is possible to update all of the wireless tag units 112-1, 112-2, . . . , and 112-n at once.

Accordingly, for updating the remote controller, when the user presses only one button for updating, it is possible to update all of the buttons. As a result, it is unnecessary to individually press the button for each function to update.

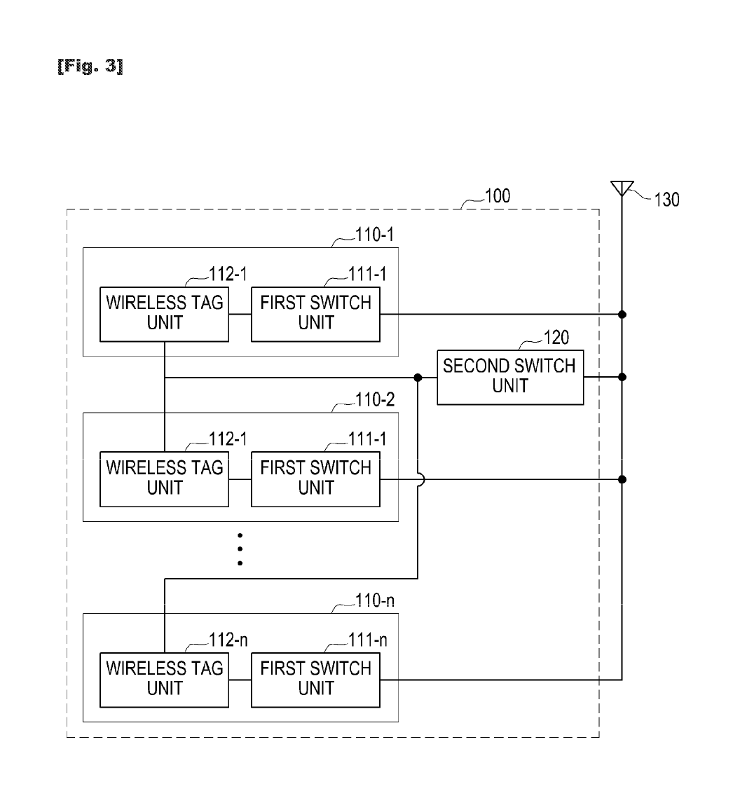

On the other hand, the first switch unit 111 and the second switch unit 120 may be configured to have a separate connection relation as illustrated in FIG. 3.

Specifically, a connection path with the first switch unit 111 and a connection path with the second switch unit 120 may be separately provided. Therefore, the connection paths, at the event of pressing a button corresponding to the first switch unit 111 and at the event of pressing a button for updating, may be independent of each other.

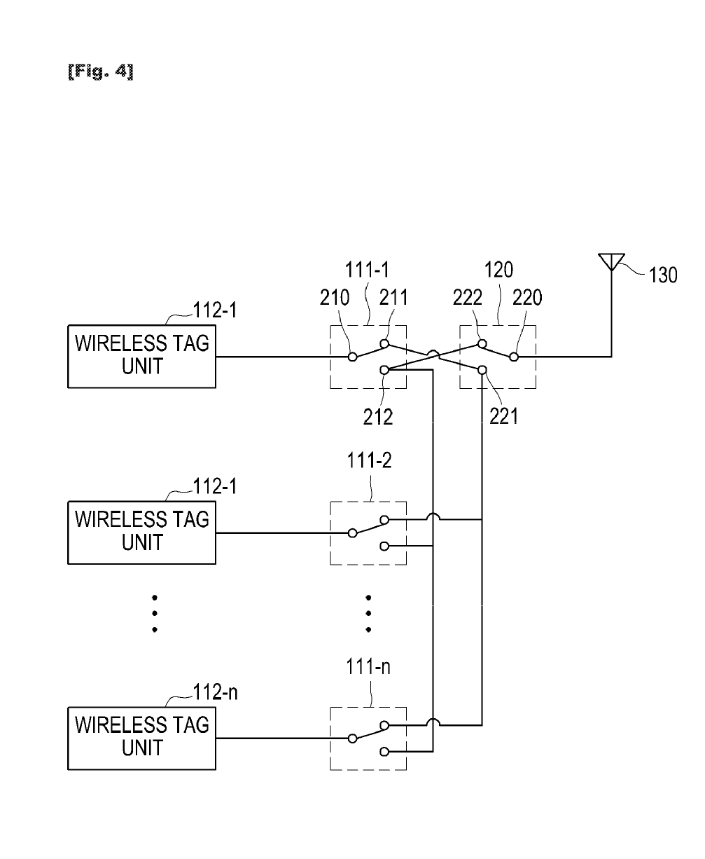

However, it is possible to configure a three-way switch as illustrated in FIG. 4.

A configuration of the first switch unit 111 and the second switch unit 120 with the three-way switch will be described with a reference to FIG. 4, focusing on the first button unit 110-1.

First, a common terminal 210 of the three-way switch (single pole double throw switch) constituting the first switch unit 111 is connected to the wireless tag unit 112 of the same button unit.

Based on whether or not the corresponding button has been selected, the first terminal, out of the first terminal 211 and the second terminal 212 involved in the connection state of the switch, is connected to the first terminal 221 of the three-way switch constituting the second switch unit 120.

When the user presses a specific button to perform a certain function, the three-way switch of the first switch unit 111 in the button is connected with the common terminal 210 and the second terminal 212 so that the wireless tag unit 112, the common terminal 210 of the first switch unit 111, the second terminal 212 of the first switch unit 111, a second terminal 222 of the second switch unit 120, a common terminal 220 of the second switch unit 120, and an antenna unit 130 are connected in this order.

On the other hand, when a button for updating is pressed, the three-way switch of the second switch unit 120 is connected with the common terminal 220 and the first terminal 221 so that the wireless tag unit 112, the common terminal 210 of the first switch unit 111, the first terminal 211 of the first switch unit 111, the first terminal 221 of the second switch unit 120, the common terminal 220 of the second switch unit 120 and the antenna unit 130 are connected in this order.

Returning to FIG. 1 again, the button unit having a wireless tag unit storing a function to indicate an update start and the button unit having a wireless tag unit storing a function to indicate an update end may be included in the plurality of button units 110-1, 110-2, . . . , and 110-n.

FIG. 1 illustrates a configuration of the remote controller for updating when information for updating is directly transmitted with RF signals from the electronic products to be controlled by the remote controller or is transmitted with RF signals from a separate device from which information for updating is transmitted. When the remote controller does not include a function key for starting these updates, in order to transmit information for updating, the user needs to go to the device from which information for updating is transmitted and to directly manipulate the device.

However, when information for updating is transmitted by the remote controller, the user need not move. Therefore, it is preferable that a function key for starting/ending the update be included in the remote controller.

When the user presses a button for starting the update, a signal for starting the update is transmitted and information for updating is transmitted from corresponding electronic products. When the user presses a button connected with the second switch unit 120 for downloading, the antenna unit 130 and the wireless tag unit of each button unit are connected to each other, and information for update received through the antenna unit 130 is transmitted to the wireless tag unit of each button unit. In this way, it is possible to simultaneously update functions of each of the buttons.

In this case, the order of pressing a button for starting the update and pressing a button for downloading may be changed.

However, as illustrated in FIG. 4, in a case in which the three-way switch is composed of the first switch unit and the second switch unit, when the second switch unit 120 for downloading an update signal is first connected (connection between the first terminal and the common terminal of the second switch unit), the connection in the first switch connected with the button (connection between the second terminal and the common terminal of the first switch unit) is disconnected when another button for function control is pressed. For this reason, in order to determine whether a button for starting the update has been pressed in the electronic products from which the update signal is transmitted based on this state information, there is a need to make a determination different from a general case.

Specifically, the wireless tag unit 112 and the antenna unit 130 are interconnected once, apart from receiving the signal for updating, and information stored in the wireless tag unit 112 is transmitted through the antenna unit 130. Accordingly, when the second switch unit 120 is connected, information stored in all of the wireless tag units 112-1, 112-2, . . . , and 112-n is transmitted.

At this time, when the user presses a specific button, the wireless tag unit connected with the button is only disconnected from the antenna unit. As a result, information stored only in the corresponding wireless tag unit may not be transmitted.

Therefore, when information about a specific wireless tag unit is not transmitted in the middle of transmitting information about all of the wireless tag units, it is determined that a button connected with the wireless tag unit is pressed. With such a configuration, even in a condition described above, it is possible to determine whether a certain button has been pressed from an external device.

Meanwhile, it is preferable that information for starting the update, which is transmitted from the remote controller, be a constant value regardless a type of electronic products, or be a constant value based on each type of electronic products, for example, a TV and an air-conditioner.

When electronic products have different information for starting the update, it is necessary for information for starting the update of each electronic product to be stored in the remote controller in advance. To achieve this, additional memory for storing this information is needed, thereby increasing costs of product manufacturing. Therefore, it is preferable that information for updating be a constant value regardless of the type of electronic products or be a constant value based on each type of electronic products.

Hereinbefore, a description in which a button for starting/ending is provided in the control group 100 has been made, but the invention is not limited thereto, and the button may be separately configured not to be included in the control group 100.

When a signal for starting/ending is constant for all of the electronic products, there is no need to update and it is unnecessary to include the button in the control group 100.

Particularly, in a case in which a plurality of control groups are provided in a single remote controller, when a button for starting/ending the update is assigned to each of the control groups, more buttons may be arranged in a narrow space. Accordingly, it is preferable that the button for starting/ending be provided independently from the control groups.

Further, a configuration connected with the button for starting/ending, the same as that of the button unit, may include the wireless tag unit. However, it is possible to implement this in a general remote controller type or other type since there is no need to update.

FIG. 1 illustrates an example in which one electronic product is controlled by a single remote controller. However, as described above, a plurality of control groups 100 illustrated in FIG. 1 may be provided so as to control a plurality of electronic products with a single remote controller.

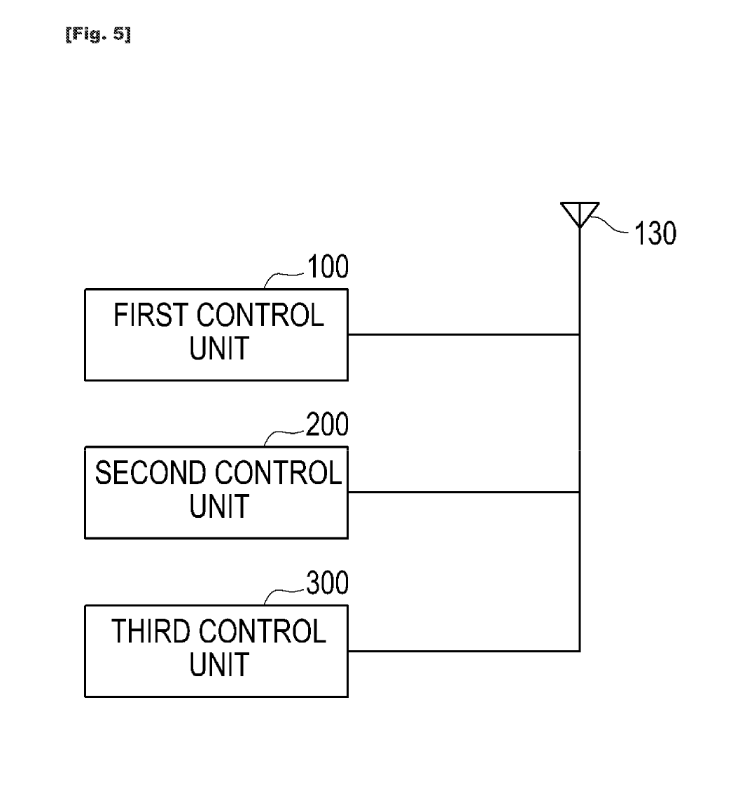

FIG. 5 illustrates a case in which the plurality of control groups are provided in one remote controller, each of the control groups 100, 200, and 300 shares the antenna unit 130, and each of the control groups independently controls electronic products.

An internal structure of each control group is the same as that in FIG. 1, and the update is performed according to the control group.

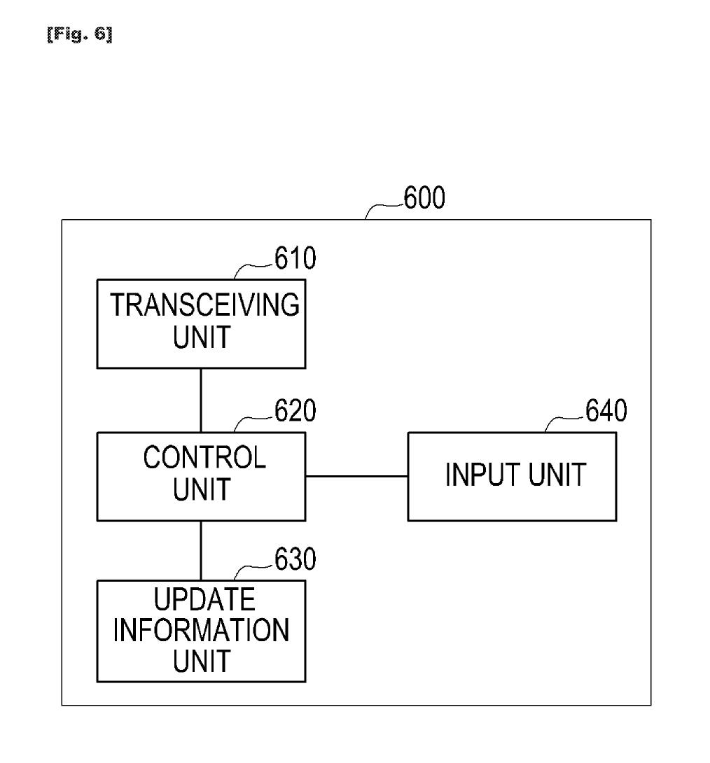

FIG. 6 illustrates a system in which update information is transmitted for updating the remote controller, which may be implemented in a separate device, or in the electronic products controlled by the remote controller.

This system is a system which performs a read/write function of the wireless tag and includes a transceiving unit 610, a control unit 620, an update information unit 630, and an input unit 640.

The transceiving unit 610 transmits a signal, which is determined to be transmitted through the control unit 620, with wireless signals such as RF signals and receives wireless signals transmitted from the external source.

The input unit 640 receives a user's input for manipulating the system using, for example, a mouse or a keyboard.

The update information unit 630 stores information for updating and creates information to be output based on the information for updating.

When only one control group is provided in the remote controller and remote controllers using the system of the invention are manufactured to have the same format, information to be output may be consistently output. In this case, the update information unit 630 performs only a function in which the stored information for updating is directly transmitted.

When different forms of updates each time or different methods of updates based on remote controllers are needed, the update information unit 630 needs to differently create information to be output for updating.

As described above, new information is recorded in the memory of the wireless tag unit connected to each button for function control provided in the remote controller in the update of the remote controller, the format of signals is determined in the same manner as that of transmitting a signal in the writer of the wireless tag, and this signal format is determined based on the communication protocol between the wireless tag and the wireless tag writer.

According to the invention, when updating information stored in the plurality of wireless tag units at the same time, it is preferable that each wireless tag unit identification information and remote controller signal information for function control of the electronic products to be stored in the wireless tag unit be included in the information for updating.

When the remote control system of the invention is manufactured in a constant form and a specific function is consistently assigned to a specific button, the remote controller signal information for each function control is stored in the wireless tag unit which is connected to the same button. In this way, the remote controller signal information corresponding to the wireless tag unit identification information may be known in advance, information thereof may be stored in the update information unit 630, and the information may be directly transmitted when the update is started.

Otherwise, since functions assigned to each of the buttons may differ depending on the remote controllers, creating new information at every update is preferable.

For example, in the remote controller provided with a plurality of control groups, in order to store remote controller signal information for controlling a TV in the first control group, there is a need to know the wireless tag unit identification information belonging to the first control group so as to create information for updating.

In this case, after the wireless tag unit identification information to be updated through a signal received from the remote controller is first identified, the update is performed such that the identification information and the remote controller signal information are simultaneously transmitted.

The wireless tag unit identification information to be updated may be identified when the second switch unit 120 is connected and the identification information stored in each wireless tag unit and the remote controller signal information are received, or all of the identification information of the wireless tag unit to be updated may be included in a signal transmitted when the user presses a button for starting the update in the remote controller.

Meanwhile, the remote control system of the invention may further include an internal component for performing a read/write function of the wireless tag so as to directly update by receiving data from an external device, which is capable of installing software for updating the electronic products, for example, a computer.

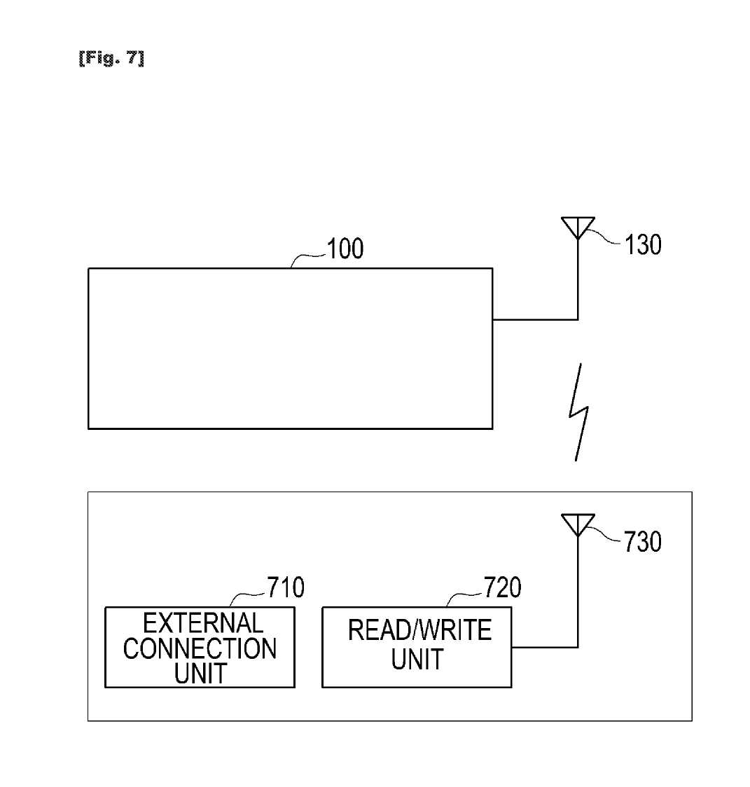

FIG. 7 illustrates an embodiment of the invention and illustrates a system having a read/write function of the wireless tag therein and capable of updating by connecting with, for example, a computer.

As illustrated in FIG. 7, the remote control system according to the embodiment of the invention includes the control group 100 connected with the first antenna unit 130 and an update unit 700 having a second antenna unit 730.

The control group 100 is the same as the control group 100 illustrated in FIG. 1. Since the internal structure of the control group 100 has been described in FIG. 1, an illustration thereof will not be repeated.

Although FIG. 7 illustrates only one control group, a plurality of control groups may be included, as illustrated in FIG. 5.

The update unit 700 receives a signal from the external device (for example, a computer) which provides update information and transmits a signal for changing remote controller signal information stored in the wireless tag unit 112 using the update information.

Specifically, the update unit 700 that includes an external connection unit 710 and a read/write unit 720 in addition to the second antenna unit 730, and updates information stored in the wireless tag unit in the control group 100 by communicating with the control group 100 through the second antenna unit 730.

The external connection unit 710 provides a connection interface with the external device having the update program installed therein and transmits and receives data to or from the external device.

Here, the computer is most commonly used as the external device having the update program installed therein and as an interface to connect with the computer, a USB interface may be preferable.

When data is transmitted using the USB, since power in addition to data may also be supplied, it is possible to update without power supply components such as a battery in the remote control system.

However, the invention not limited thereto, data may be received via wireless communication, for example, Bluetooth, and the external connection unit 710 may provide an interface for Bluetooth.

The read/write unit 720 that reads information of the wireless tag in the control group 100, transmits information to the external device, and receives information for updating from the external device, changes the information into a signal to write in the wireless tag and transmits to the corresponding wireless tag so as to update.

The second antenna unit 730 performs data transceiving between the read/write unit 720 and the button unit 110 via wireless communication through the antenna unit 130.

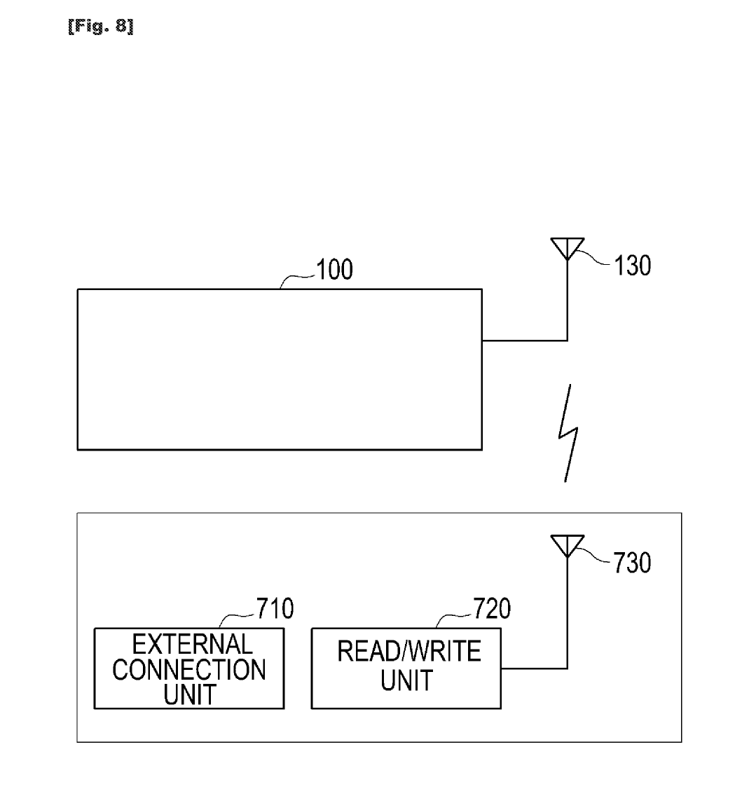

Even when the update is performed using the remote control system illustrated in FIG. 7, the user connects the second switch unit 120 so as to update while all of the wireless tag units are connected with the first antenna unit 130. FIG. 8 illustrates an example of an update system implemented in, for example, a computer.

An update system 800 implemented in, for example, a computer, includes an external connection unit 810, a control unit 820, an update information unit 830, and an input unit 840.

The external connection unit 810 is connected to the external connection unit 710 of the remote control system in FIG. 7, such as a USB interface, in a wired or wireless manner, and performs data transceiving.

The input unit 840 is provided with a keyboard or a mouse to receive a user's input.

The update information unit 830 stores information for updating the electronic products and creates update information to be transmitted to the update unit 700 based on the information and the user's selection.

The control unit 820 that controls update information creation of the update information unit 850, transmitting and receiving of information, and a screen output according to user's input through the input unit 840.

The output unit 850 that outputs, for example, a creation progress of the update information, and a test situation, on the screen.

As compared to the update system provided in the electronic products as illustrated in FIG. 6, since the update system installed in the computer as illustrated in FIG. 8 can download the update information on various electronic products through a web browser 860, it is possible to easily update for various electronic products and to easily adjust a function assigned to each button while viewing the monitor screen.

For example, when the user connects the remote control system illustrated in FIG. 7 with the update system as illustrated in FIG. 8, executes the update program, and connects the second switch unit 120 so as to perform data transceiving with each wireless tag unit, the control unit 820 performs control such that all wireless tag information provided in the control group 100 is output on the screen through the output unit 850.

At this time, when the type of remote controller is identified based on information received from the remote control system, that is, when information about a shape of corresponding remote controller is stored in the update information unit 830, it is preferable that the shape of connected remote controller be output through the output unit 850.

When the user selects a desired electronic product in the electronic product update information stored in the update information unit 830, function information executable with the remote controller in the electronic product is provided to the user through the output unit 850, and the user can match each function with each button of the remote controller.

In the update information unit 830, information for updating each wireless tag unit is created according to information matched by the user, this update information is transmitted to the read/write unit 720 through the external connection units 810 and 710, and the read/write unit 720 changes information stored in the wireless tag unit in the control group 100 through the second antenna unit 730 and the first antenna unit 130.

The update system provided in the electronic products as illustrated in FIG. 6 may perform the above-described operations, but a separate output screen is needed and a matching operation between each button and function may be quite cumbersome using only direction keys of the remote controller.

Meanwhile, when the computer is used, without directly executing the function with respect to the electronic products, it is possible to check whether the update has succeeded through the computer screen.

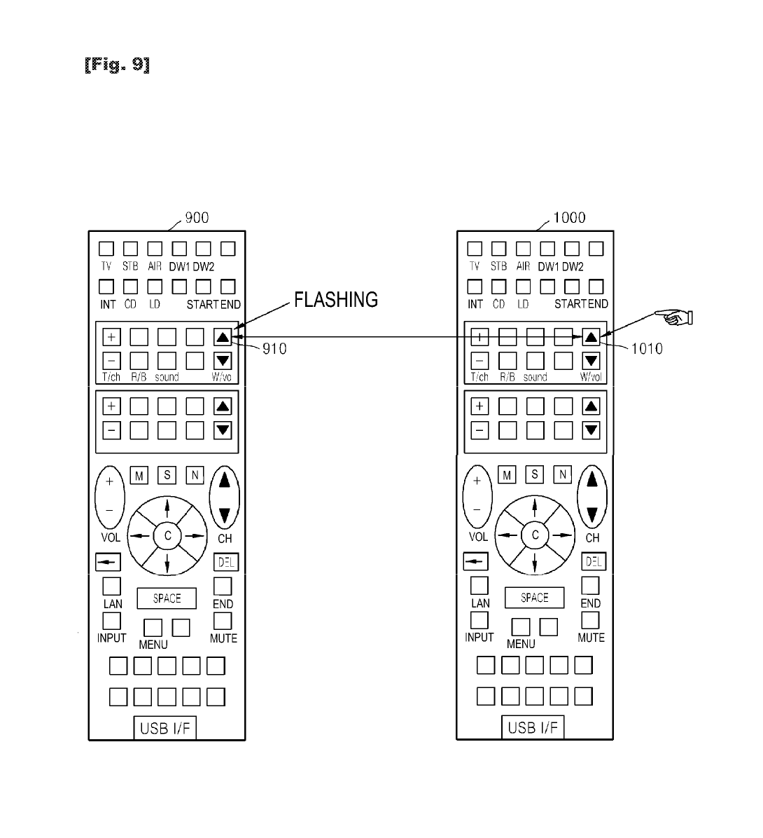

For example, it is possible to test using the screen as illustrated in FIG. 9.

In FIG. 9, a left-side remote controller is a remote controller 900 which is output onto the screen through the output unit 850 of the computer, and a right-side remote controller 1000 is an actual remote controller manipulated by the user.

When the user presses a specific button 1010, the remote controller signal information corresponding to the button is transmitted to the update system 800 through the first antenna unit 130, the second antenna unit 730, the read/write unit 720, and the external connection unit 710, and the control unit 820 of the update system 800 allows the corresponding button 910 to flash through the output unit 850, thereby showing that the updated button is operating properly.

Further, it is preferable that the meaning of the function assigned to the corresponding button be output.

The above-described methods of the invention may be implemented by a computer-readable code in a computer-readable recording medium. The computer-readable recording medium includes any type of data storage device storing data that can be read by a computer system. Examples of recording medium include a ROM, a RAM, a CD-ROM, a magnetic tape, a floppy disk, an optical data storage device, and a medium implemented in the form of carrier waves (for example, transmission via the Internet). In addition, the computer-readable recording medium is distributed to computer systems connected over the network so that the computer-readable code is stored and executed in a distributed manner.

1. A remote control system having an updatable wireless tag, the system comprising:
an antenna unit that transmits and receives wireless signals;
a plurality of button units, each of which includes a wireless tag unit and a first switch unit, wherein when a corresponding button provided in a remote controller is selected, remote controller signal information for controlling a function of an electronic product stored in the wireless tag unit is transmitted through the antenna unit; and
a second switch unit that interconnects the antenna unit and each wireless tag unit provided in the plurality of button units such that information for updating the remote controller, which is received from an external source, may be simultaneously transmitted to each wireless tag unit when a button for updating the remote controller is selected,
wherein the wireless tag unit of the button unit stores inherent identification information of the wireless tag unit and the remote controller signal information, and
the first switch unit connects the wireless tag unit with the antenna unit when a button corresponding to the button unit is selected, and
information for updating the remote controller includes the identification information of the wireless tag and remote controller signal information to be stored in a wireless tag corresponding to the identification information.

2. The remote control system having an updatable wireless tag of claim 1,
wherein the wireless tag unit is configured to simultaneously transmit remote controller signal information and the identification information of the wireless tag.

3. The remote control system having an updatable wireless tag of claim 1,
wherein a connection path with the first switch unit and a connection path with the second switch unit are independently provided.

4. The remote control system having an updatable wireless tag of claim 1,
wherein the first switch unit and the second switch unit are configured with a three-way switch;
a common terminal of the first switch unit is connected to the wireless tag unit;
a first terminal of the first switch unit is connected to a first terminal of the second switch unit;
a second terminal of the first switch unit is connected to a second terminal of the second switch unit;
the common terminal of the first switch unit is connected to the second terminal of the first switch unit when a button corresponding to the first switch unit is selected; and
a common terminal of the second switch unit is connected to the first terminal of the second switch unit when a button corresponding to the second switch unit is selected.

5. The remote control system having an updatable wireless tag of claim 1, further comprising:
a button configured to transmit a signal indicating the update; and
a button configured to transmit a signal indicating the end of the update.

6. The remote control system having an updatable wireless tag of claim 1,
wherein a plurality of control groups each have the button unit and the second switch unit so as to control different electronic products according to the control group.

7. The remote control system having an updatable wireless tag of claim 1, further comprising:
an update unit that receives a signal from an external device which provides update information and transmits a signal for changing the remote controller signal information stored in the wireless tag unit using the update information.

8. The remote control system having an updatable wireless tag of claim 7,
wherein the update unit includes;
an external connection unit that transmits and receives data to or from the external device;
a read/write unit that generates a signal for changing the remote controller signal information stored in the wireless tag unit using the update information received from the external device through the external connection unit, and transmits information received from the antenna unit to the external device through the external connection unit; and
a second antenna unit that performs data transceiving between the read/write unit and the button unit via wireless communication with the antenna unit.

9. The remote control system having an updatable wireless tag of claim 7,
wherein the external device is a computer.
